(19) United States
(12) Patent Application Publication
(10) Pub. No.: US 2022/0396458 A1
(43) Pub. Date: Dec. 15, 2022

(54) INTELLIGENT PLATFORM

(71) Applicant: Terry Foley, Oklahoma City, OK (US)

(72) Inventor: Terry Foley, Oklahoma City, OK (US)

(21) Appl. No.: 17/838,990

(22) Filed: Jun. 13, 2022

Related U.S. Application Data
(60) Provisional application No. 63/202,450, filed on Jun. 11, 2021.

(51) Int. Cl. B66F 7/08; B66F 13/00; B66F 17/00; B66F 7/26

(52) U.S. Cl. CPC B66F 7/08; B66F 13/00; B66F 17/006; B66F 7/26

(57) ABSTRACT

An intelligent platform may employ a unitary platform positioned between articulating legs with each articulating leg connected to a leveling module. The leveling module can be configured to execute a leveling strategy that involves extending at least one articulating leg to establish the unitary platform in a level orientation relative to an underlying, non-level terrain.

### RELATED APPLICATION

The present application makes a claim of domestic priority under 35 U.S.C. 119(e) to copending U.S. Provisional Patent Application No. 63/202,450 filed Jun. 11, 2021, the contents of which are hereby incorporated by reference.

### SUMMARY

An intelligent platform, in accordance with some embodiments, has a unitary platform positioned between articulating legs with each articulating leg connected to a leveling module. The leveling module can execute a leveling strategy that involves extending at least one articulating leg to establish the unitary platform in a level orientation relative to an underlying, non-level terrain.

Embodiments of an intelligent platform detect a non-level terrain with at least one sensor connected to a leveling module before generating a leveling strategy with the leveling module in response to the detected terrain. After positioning a unitary platform proximal to the terrain, the leveling strategy is executed with the leveling module to activate at least one articulating leg attached to the unitary platform to establish a level orientation relative to the underlying, non-level terrain.

These and other features which may characterize various embodiments can be understood in view of the following detailed discussion and the accompanying drawings.

### BRIEF DESCRIPTION OF THE DRAWINGS

FIG. 1 depicts portions of an example terrain in which assorted embodiments may be practiced.

FIG. 2 depicts a line representation of portions of an example intelligent platform configured in accordance with some embodiments.

FIGS. 3A and 3B respectively depict portions of an example intelligent platform constructed and utilized in accordance with various embodiments.

FIG. 4 depicts aspects of an example intelligent platform employed in accordance with assorted embodiments.

FIGS. 5A & 5B respectively depict a line representation of portions of an example intelligent platform configured in accordance with some embodiments.

FIG. 6 depicts a block representation of an example leveling module that may be employed by an intelligent platform in accordance with various embodiments.

FIG. 7 depicts a line representation of portions of an example articulating leg capable of carrying out assorted embodiments as part of an intelligent platform.

FIG. 8 depicts a line representation of portions of an example intelligent platform configured in accordance with assorted embodiments.

FIG. 9 is a flowchart of an example leveling routine that can be carried out with the various embodiments of FIGS. 1-8.

### DETAILED DESCRIPTION

Generally, embodiments disclosed herein are directed to an intelligent platform arranged to carry out a leveling strategy to provide a perfectly level, flat, and horizontal operating surface over terrain that is not uniformly level, flat, or horizontal.

As greater automation capabilities evolve through the sophistication of computing, mobile power, and communications technologies, operations can be conducted farther away from computing and power sources. The ability to utilize automation, robotics, and computing operations outside of population centers can rely on having a rigid, level foundation to secure assorted equipment, such as racks, loose materials, machines, and vehicles. The use of a level foundation allows equipment to be reliably maintained in position while operating without danger of gravity altering the position or function of the equipment. However, many locations have terrain that poses difficulties in establishing and maintaining a level foundation.

With these issues in mind, assorted embodiments provide an intelligent platform that has self-leveling and all-terrain capabilities that allow sophisticated computing, robotics, and automation operations in environments that do not often have flat, stable surfaces. An intelligent platform can evaluate and map various terrain surfaces to determine if a level surface can be accurately established and maintained with the capabilities of the platform. By not attempting to place a platform on terrain that is deemed not conducive to level and stable operation, resources, such as time, labor, and energy, are not wasted and equipment damage is not risked. Through the generation and execution of a strategy to establish and maintain a rigid, level, and secure surface, an intelligent platform can be utilized in a diverse range of locations to allow sophisticated and unsophisticated equipment to be utilized and deployed.

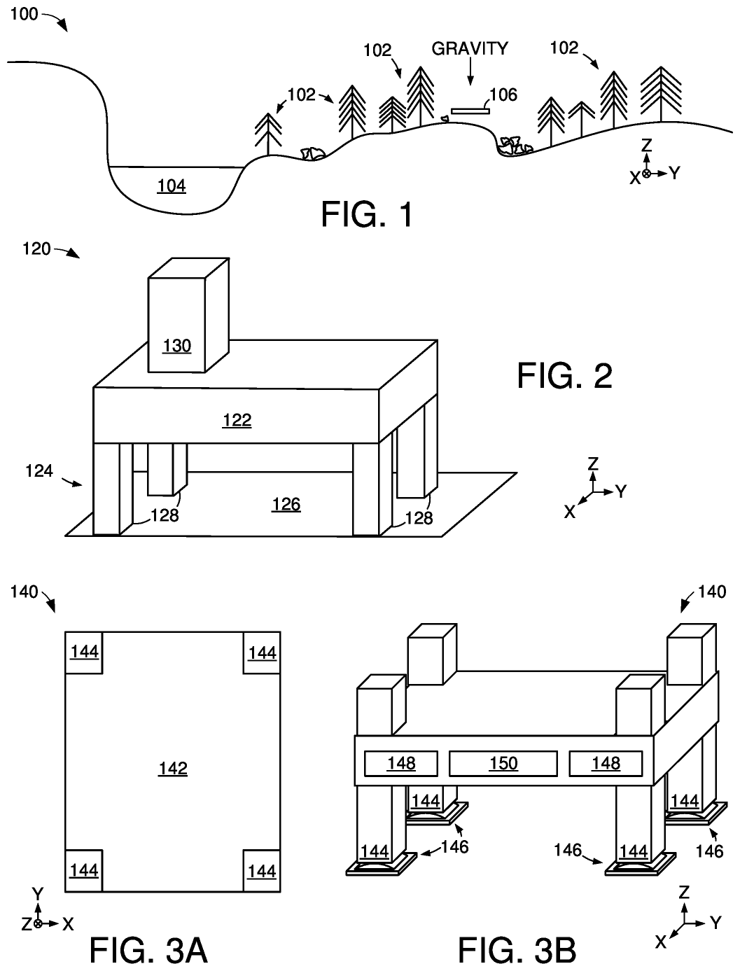

FIG. 1 displays a line representation of portions of an example environment 100 in which assorted embodiments can be practiced. The environment 100 can consist of any number of surfaces, climates, creatures, and flora. The non-limiting environment 100 of FIG. 1 has a plurality of trees 102 and a body of water 104 separated by undulating terrain that can support a diverse range of animals, plants, rocks, turf, and soil. While a flat platform 106 may be physically positioned at assorted locations throughout the environment 100, such as on the water 104 or on a hillside, the terrain do not provide a large enough level surface for the platform 106 to have a level orientation that is perpendicular to the Earth's gravity, as shown. Thus, there are numerous difficulties with arranging a flat platform 106 in a stable level configuration without a pre-existing level foundation that are rarely found in nature.

FIG. 2 conveys a line representation of portions of an example platform 120 that can be used in various embodiments. The platform 120 has a rigid and flat body 122 connected to a suspension 124 that can adjust the orientation of the platform body 122 to a variety of different positions relative to an underlying surface 126. The suspension 124 may consist of any number of mechanical, hydraulic, or pneumatic components that can be manually or automatically articulated to adjust the position of one or more legs 128, which alters the configuration of the platform body 122. It is contemplated that individual components of the suspension 124 can be adjusted for length and/or orientation relative to the platform body 122.

In some embodiments, the suspension 124 is self-leveling and automatically adjusts one or more components, such as a leg 128, piston, airbag, or screw, to establish and maintain the platform body 122 in a level orientation, which may or may not be parallel to some or all of the underlying surface 126. While a self-leveling suspension 124 can provide automatic adjustments to compensate for an unlevel underlying surface 126, the leveling aspects of the suspension 124 can be delicate and sensitive to dirt, debris, and environmental conditions found outside of locations with conditioned surfaces, such as hospitals, paved roads, and restaurants. In other words, existing self-leveling suspensions 124 are not robust enough to provide a level platform body 122 consistently in locations without pavement, relatively flat surfaces, and protection from variations in temperature, humidity, wind, and airborne contaminants.

Regardless of the configuration of the suspension 124, it is contemplated that platform 120 stability can be jeopardized in some suspension component configurations. For instance, extension of a leg 128 past a particular length or rotation of a leg 128 past a particular orientation to the body 122 can alter the center of gravity of the body 122 to a point where slight variations in a supported load 130 can compromise the balance and integrity of the suspension 124 and platform 120 as a whole. Hence, the ability of a suspension 124 to provide adjustability can correspond with a susceptibility to imbalance and/or instability in certain positions, particularly with some heavy and/or unbalanced loads 130 on surfaces 126 that are not covered, paved, or otherwise in an unnaturally occurring condition.

FIGS. 3A & 3B respectively depict aspects of an example intelligent platform 140 configured in accordance with assorted embodiments. The top view of FIG. 3A illustrates how the platform 140 has a unitary rigid body 142 positioned between four legs 144. Although the location of the respective legs 144 relative to the body 142 is not limited, various embodiments position the legs 144 proximal each corner of the body 142, as shown. The configuration of the body 142 is also not limited and can be any shape, size, and material construction. However, some embodiments configure the platform body 142 as single pour of concrete with a predetermined strength, such as greater than 25,000 psi throughout the body 142.

The respective legs 144 can each have a foot 146 that contacts an underlying surface to support the platform body 142. The side view of FIG. 3B conveys how the respective feet 146 can have an articulating connection to the legs 144, such as with a loose joint or selectively activated assembly. For instance, a foot 146 can be mechanically, hydraulically, or pneumatically articulable to a variety of orientations relative to the platform body 142 to engage an underlying ground surface to establish and maintain the entire body 142 in a level orientation, perpendicular to gravity. It is contemplated that at least one foot 146 is free of actuation and can loosely articulate automatically in response to contact with a ground surface to physically support the leg 144 in an orientation that is parallel to gravity.

The unitary platform body 142 can have any number and type of attachments that may be imbedded into the platform body material or physically connected to the body 142, such as with fasteners, adhesive, or rigid mounts. One such attachment may be an electrical sensor 148 that is connected to a local control module 150 that directs operation of the assorted aspects of the platform 140. The combination of one or more sensors 148 and the computing intelligence provided by the control module 150 allows the platform 140 to establish and maintain a level orientation despite an underlying surface being undulating, non-level, and/or comprising loose materials.

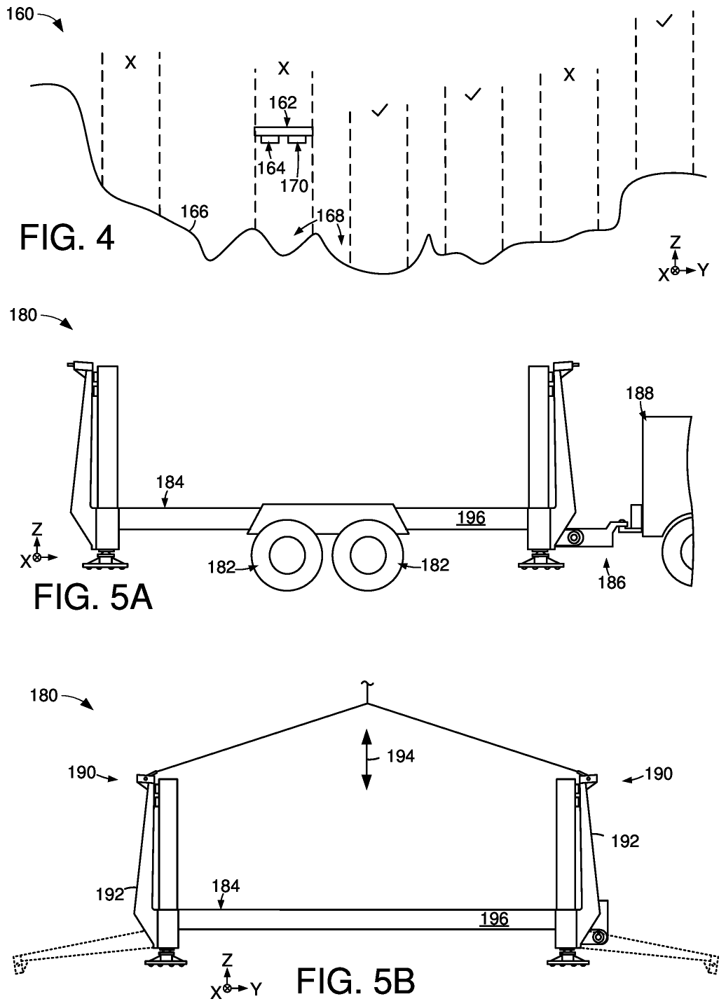

The intelligence and computing capabilities provided by the control module 150 can allow different portions of terrain to be evaluated prior to deployment of one or more feet 146. FIG. 4 depicts a line representation of an example platform environment 160 in which on board sensing and computing capabilities of an intelligent platform 162 can map and evaluate different portions of a terrain to determine where level platform deployment can occur. The platform 162 can employ one or more sensors 164, such as optical, mechanical, and acoustic detectors, to identify assorted aspects of the ground surface 166. For example, platform mounted sensors 164 can generate a map of the ground surface 166 to identify the presence of obstacles to level platform deployment, such as slope, cliffs, depressions 168, rocks, debris, water, and trees.

Terrain mapped by the platform sensors 164 in combination with on board computing intelligence of the control module 170 can involve the determination of numerous different ground surface 166 characteristics, such as slope, average undulation, and ground material density. The compilation of ground surface 166 characteristics, which can be characterized as terrain identification, allows the platform control module 170 to determine if and how a level platform 162 orientation can be established and maintained. As shown, the platform control module 170 can evaluate multiple different ground surface regions, as illustrated by segmented lines, and determine that level platform orientation is not possible, not stable over time, or both in rejecting some regions, as conveyed by an X, and accepting other regions, as conveyed by a check mark.

The ability to evaluate different portions of a terrain for compatibility to support a level platform over time allows the platform control module 170 to determine the optimal platform 162 position, as characterized as quickest to establish a level platform, most stable level platform position, or least risk of platform damage during deployment as determined by the platform control module 170. It is contemplated that the platform control module 170 provides optionally acceptable terrain regions to a user for manual selection of where the platform 162 will be deployed to establish a level surface over time. In some embodiments, the use of sensors 164 to map portions of the ground surface 166 can result in instructions to ready a site for level and stable platform deployment, such as removing debris, clearing rock, or filling holes.

Through assorted embodiments, an intelligent platform 162 is self-deploying by automatically establishing a level platform surface and maintaining that orientation over time. Prior to self-deployment, a platform 162 can be transported to a site in an unlimited variety of manners. For instance, the platform 162 may consist of a hitch, receiver, or capture assembly that allows a ground vehicle to move and manipulate the platform 162. FIG. 5A depicts portions of an example intelligent platform 180 configured for ground transportation with wheels 182 that may have solid, inflatable, or flexible unitary construction. One or more wheels may be articulable to allow steering and/or powered through electric, hydraulic, pneumatic, or mechanical energy transfer.

The assorted wheels 182 may be removed, rotated, or manipulated after platform 180 deployment to control the balance and center of gravity of the platform. As a non-limiting example, wheels may be moved after the platform establishes a level orientation to change where the platform's center of gravity is located. It is contemplated that wheels are moved to control the platform's center of gravity after a load contacting an upper surface 184 is installed, moves, or changes. That is, the wheels 182 can be manipulated to change the center of gravity for the platform 180 including any load supported by the platform 180. The use of wheels is not required and other ground traction components, such as tracks, sleds, or air-cushions, can be employed alone, or in combination with wheels 182.

Ground transportation of the platform 180 is provided by a towing mechanism 186 that attaches to a ground-based vehicle 188, such as a truck, tank, or hovercraft. The towing mechanism 186 is not limited to a particular configuration, but can consist of a retractable arm that physically attaches to the vehicle 188. It is contemplated that various electrical and/or fluid connections can also extend from the vehicle 188 to the platform 180 to provide power, fuel, and control signals.

FIG. 5B depicts how the intelligent platform 180 can be configured for air transportation with a hoist assembly 190 that consists of at least a pair of arms 192 that translate centralized force 194, such as from a plane, helicopter, or other aerial vehicle, to a periphery of the platform body 196, which transports the platform 180 in an orientation that is ready for deployment without disconnecting the hoist assembly 190 from the source of force 194. While the platform 180 may be transported in a position where the force 194 is applied parallel to a longitudinal axis of the platform body 196, such arrangement would require the platform 196 to be rotated, such as through disconnecting or rotating, portions of the hoist assembly 190, which can complicate the positioning of the platform 180 for ground contact and subsequent self-deployment.

Although not required or limiting, the arms 192 of the hoist assembly 190 can distribute the force 194 to the platform body 196 in a first position, as shown by solid lines in FIG. 5B, and subsequently rotate to engage the ground surface in a second position, as shown by segmented lines, to provide additional support to maintain the platform in a level orientation. It is contemplated that one or more arms 192 are manually deployed by an on-site user or are automatically deployed via an articulation mechanism, such as a magnetic, hydraulic, pneumatic, or mechanical moving means. Embodiments of an articulating arm 196 have articulable feet, similar to the feet of the legs, that can be manually or automatically manipulated to engage a ground surface and support the platform.

In the embodiment shown in FIG. 5B, the hoist assembly 190 is arranged to divert force 194 around and away from the platform top surface 184. That is, the respective arms 192 translate the force 194 from a central location relative to the platform body 196 to a periphery of the platform body 196, such as a corner joint or outer edge of the platform body 196, without inflicting force on any items supported by the platform top surface 184.

As such, the respective arms 192 can protect any load residing on the platform body 196 while the platform 180 is transported by air. One or more respective arms 192 can, in some embodiments, rotate relative to the platform body 196 to contact terrain outside the areal extent of the body 196, as illustrated by segmented lines, to provide additional physical support and stability for the center of gravity of the platform 180.

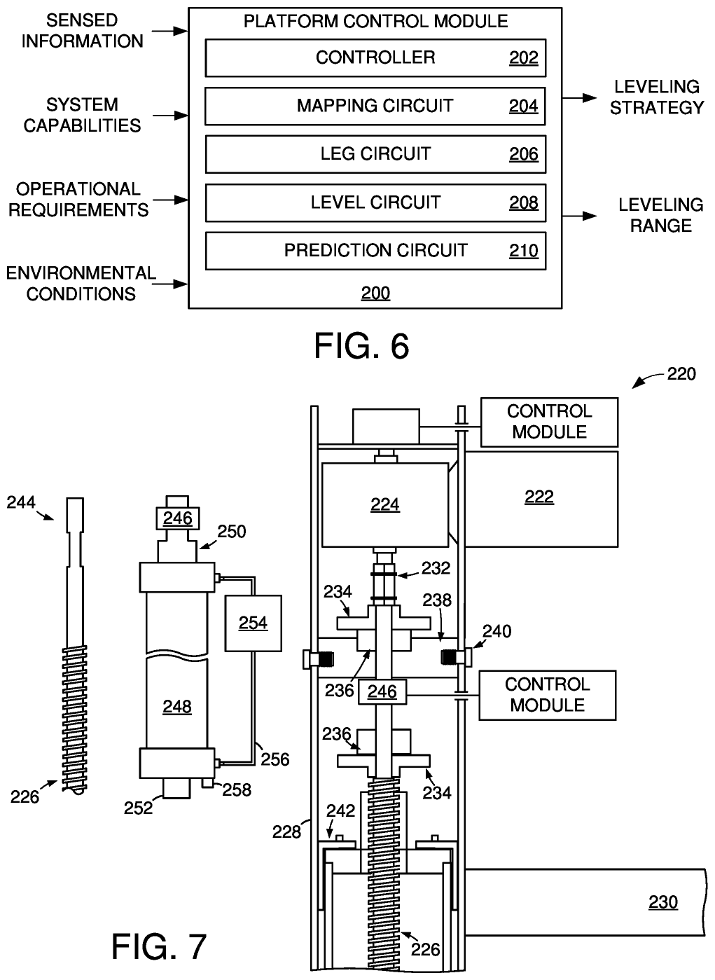

A block representation of an example platform control module 200 that can be employed in an intelligent platform is displayed in FIG. 6. The platform control module 200 may be resident as hardware and/or software that is physically located on an intelligent platform. Some embodiments arrange the platform control module 200 to be physically located off of an intelligent platform with complementary circuitry physically located on the intelligent platform that carries out a leveling strategy generated by the platform control module 200 via a wired and/or wireless signal pathway from the module 200 to the electrical aspects of the platform. The module 200 can engage one or more circuits to translate input information, such as data from sensors, current component status, component factory capabilities, environmental data, and operational requirements, to create a leveling strategy that consists of a leveling range and operational triggers that prompt the alteration of one or more platform parameters.

A local module controller 202 can be a microprocessor or other programmable circuitry that provides computing intelligence to proactively generate a leveling strategy and reactively execute actions prescribed by the strategy in response to detected and/or predicted platform conditions. The local controller 202 can operate alone, or with other module circuitry, to evaluate past and current platform conditions and activity to create, execute, and maintain assorted operating settings of the leveling strategy. In some embodiments, the local controller 202 operates with a mapping circuit 204 to evaluate one or more aspects of a terrain.

The mapping circuit 204 can poll one or more platform sensors and other information, such as topographical maps, to discern information about a terrain, such as the ground slope, undulation, covering material, type of vegetation, location of debris, size of trees, and stability. Through the evaluation of terrain by the mapping circuit 204, the leveling module 200 can proactively generate a new leveling strategy, or alter an existing leveling strategy, that optimizes platform deployment to the specific terrain in which the platform will be deployed to provide a stable and level surface.

The leveling strategy can consist of operational ranges, current status, and a variety of deployment actions for assorted aspects of an intelligent platform. A leg circuit 206 can monitor current deployment capabilities for the various legs of an intelligent platform and provide the leveling strategy with leg-specific actions, such as extension speed, extension length, extension force, and foot orientation, along with leg-specific ranges, such as possible extension height, extension speed, extension force, and foot configurations. The leg circuit 206 may populate the leveling strategy with one or more reactions to predetermined operational triggers, such as a movement in the platform's center of gravity or unexpected platform tilt, that prevent deviations from optimal level platform position from continuing.

In some embodiments, the leg circuit 206 generates separate operational settings for platform deployment and platform position maintenance. For instance, the leveling strategy can consist of at least one leg operational setting created by the leg circuit 206 to deploy and contact a ground surface to establish the platform in a level configuration and at least one operational setting directed to maintain the platform's level configuration over time after previously being established. The ability to proactively create operational settings for deployment and platform position maintenance allows for efficient execution of a deployment process as well as efficient mitigation of dynamic conditions that could jeopardize the integrity of a platform's level orientation.

While various non-limiting manners can be utilized to detect and maintain a platform in a level orientation relative to gravity, a level circuit 208 can access one or more sensors of a platform to determine the current and future position and orientation of a platform's top surface. It is contemplated, but not required, that the level circuit 208 determines the position of one or more things supported by the platform's top surface. That is, the level circuit 208 can access sensors, gyroscopes, and/or manual input to determine the number, location, and center of gravity for items that are loose or connected to a top surface of the platform.

The dedication of a level circuit 208 to determining the current and eminent position of a load supported by a platform as well as the orientation of the platform's top surface relative to gravity allows the leveling strategy to efficiently execute proactive and reactive operational setting deviations to establish and maintain a level configuration for the platform. The determination of the position and center of gravity of a supported load allows for temporary operational settings for the platform, set by the level circuit 208, to alter the platform configuration and prevent a load from moving. For instance, during deployment, the level circuit 208 can detect the center of gravity for a supported load has moved and alters the deployment operational setting of at least one leg and/or foot to temporarily orient the platform in a non-level configuration to alter the load's center of gravity until the platform is stable and a level configuration can be established without jeopardizing the position of a supported load.

The detection of one or more static or dynamic platform conditions allows a prediction circuit 210 to forecast one or more future conditions. The prediction circuit 210 can input a variety of different current conditions, such as leg position, leg downward force, foot orientation, ground surface information, supported load information, and platform center of gravity, to predict at least one future condition of the platform and/or supported load. The accurate prediction of future platform and/or load conditions informs the module controller 202 to execute one or more operational setting deviations to prevent the predicted condition from occurring or mitigate the impact of the predicted condition on the stability of the platform and the integrity of the platform's level orientation relative to gravity.

With the prediction circuit 210 translating current platform, ground, and supported load information into future conditions, the leveling module 200 can perform actions that control how, and if, the future conditions occur. As a non-limiting example, detection of current leg force increasing after a platform is established in a level orientation can be translated into a prediction that the ground surface is unstable and execution of an alteration to one or more legs and/or feet to further stabilize the platform and maintain the platform's level orientation relative to gravity. The prediction circuit 210 further allows for intelligent platform deployment as current sensed ground, leg, foot, load, and platform conditions can be used to predict how a first platform deployment process to contact the ground will occur, which can prompt the module controller 202 to select a second deployment process or setting that consists of different leg and/or foot movement and/or configurations to establish a level and stable platform configuration.

In FIG. 7, portions of an articulating leg 220 are displayed as line representations. The articulating leg 220, in accordance with assorted embodiments, has a motor 222 coupled to a worm gearbox 224 that translates motor power into rotation of a shaft 226 that moves an outer leg 228 in relation to a platform 230. That is, rotation of the shaft 226 by the motor 222 extends, or retracts, the outer leg 228 with respect to the platform 230, which allows the outer leg 228 to move to establish and maintain the platform 230 in a level orientation relative to gravity.

It is contemplated that the shaft 226 is interchangeable and attached to the gearbox 224 via a clamp 232, which allows for repair and/or replacement of the shaft 226 upon damage or change in shaft articulation configuration. Any number of bushings 234 can be positioned throughout the length of the shaft 226 to restrict lateral movement of the shaft 224 and ensure rotation of the shaft 224 results in precise, efficient, and accurate outer leg 228 movement relative to the platform 230. At least one thrust bearing 236 can be positioned to support an axial load along a longitudinal axis of the shaft 226 while allowing smooth and efficient shaft rotation. With a screw-type shaft 226 configuration, as shown, a corresponding nut 236 mechanically translates shaft 226 rotation into a physical position of the outer leg 228 and platform 230.

While not required or limiting, at least one bearing 238 can be physically attached to the outer leg 228 by one or more fasteners 240, such as a screw, rivet, pin, key, or magnet. A side load bearing 242 may be constructed of a damping material, such as plastic, rubber, polymer, or ceramic, to control the translation of shaft rotation to outer leg 228 vertical movement, along the Z axis. In the exploded view of the example shaft 226, a keyed section 244 provides one or more recesses to allow secure clamp 232 engagement with the shaft 226 without impinging the rotation of the shaft 226. It is noted that any number, type, and size of bushing, bearing, or collar can be utilized to efficiently and accurately translate shaft rotation into vertical outer leg 228 movement.

Various embodiments position one or more sensors in, and/or around, an articulating leg 220 to detect assorted operational aspects of at least shaft 226, outer leg 228, and motor 222. For instance, a load cell 246 can be positioned to surround the shaft 226 and detect force proximal the shaft 226. Assorted other optic, acoustic, and mechanical sensors can be positioned within a leg to monitor the real-time operating parameters of any portion of the shaft 226, motor 222, and gearbox 224 as well as operating conditions relative to an attached platform 230, such as pitch, slope, tilt, camber, and distance from a ground surface.

In some embodiments, the shaft 226 is replaced, or supplemented, with a hydraulic actuator 248 that employs a hydraulic chamber connected to a mount 250 that allows for selected movement of a piston 252 in response to one or more valve blocks 254. As shown, a load cell 246 can be positioned proximal a hydraulic actuator 248 to provide information about the status, performance, and condition of at least the piston 252, chamber, and valve block 254. It is noted that the piston 252 can be physically attached to a portion of the outer leg 228 so that movement of the piston 252 directly moves the outer leg 228 and connected foot. It is contemplated that various hydraulic components are connected to the actuator 248, such as an accumulator, pop-off valve, filter, hydraulic pump, hydraulic motor, and assorted supply and return lines 256. It is also contemplated that the hydraulic actuator 248 provides a mounting point for sensors 258 directed to map terrain for a leveling module 200.

The variety of sensed information allows a connected leveling module to accurately and efficiently determine the current status of a leg 220 and platform 230 as well as predict how execution of a leveling strategy will impact the position of the platform 230 along with the center of gravity of one or more items supported atop the platform 230. That is, a non-limiting utilization of one or more leg 220 sensors provides information to the leveling module in order to determine if a leveling strategy is being executed correctly, prescribes the most efficient leg 220 actions to establish a level platform 230, and is likely to maintain the position of items positioned on top of the platform 230 while the leg 220 is articulated to engage a ground surface to support a level platform 230 position. The leg sensors may further detect how a foot portion of a leg 220 is engaging a ground surface. For example, sensors can detect if a stable foot position has been established, when a foot has made contact with a ground surface, and if ground surface conditions are changing, which allows the leveling module to execute one or more reactive and/or proactive alterations to foot and/or leg operating parameters, such as position, orientation, or applied downward force, to maintain the level orientation of the platform relative to gravity and the center of gravity of one or more items supported by the platform.

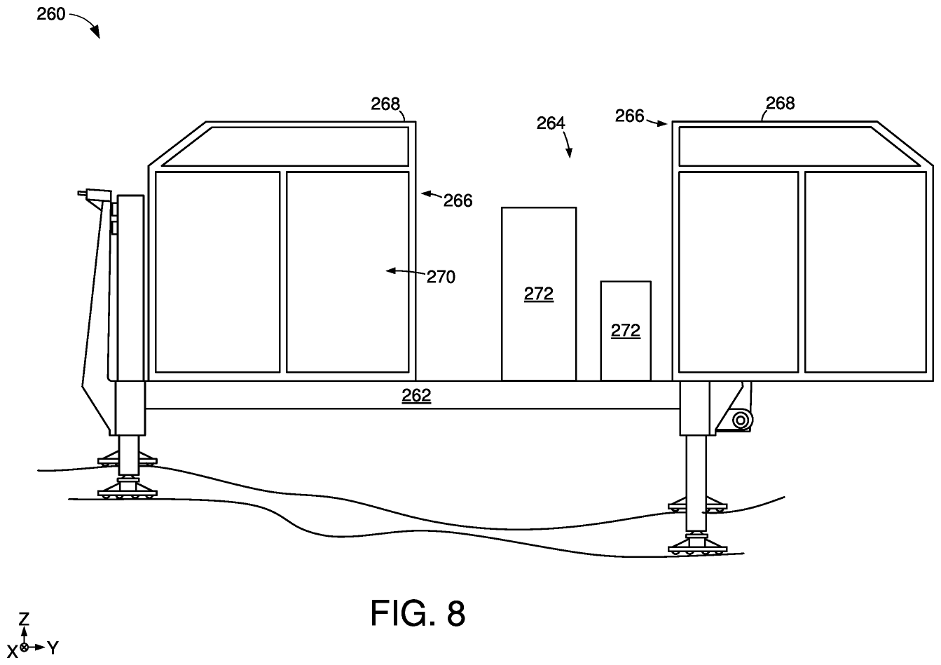

FIG. 8 depicts a line representation of portions of an example intelligent platform 260 constructed and operated in accordance with some embodiments. While a platform body 262 may be uncovered, it is contemplated that at least some of the body 262 is covered, which can protect, conceal, and insulate a space 264 above the platform body 262.

As shown, the platform body 262 is covered by a cage 266 that defines the space 264 by continuously extending to surround a periphery of the body 262. The cage 266 may be constructed of any material and may be any size and shape, but some embodiments arrange the cage 266 to have a rigid frame 268, such as metal, wood, or polymer, that supports multiple panels 270, such as chain-link, canvas, metal, wood, polymer, rubber, or ceramic materials. The material, size, and shape construction of the cage 266 can be selected to provide any variety of functional purposes, such as shield, hide, or isolate the space 264 while containing any items 272 supported by the platform body 262. The cage 266, and partially or fully enclosed space 264, can house any number of items 272 that may be loose or attached to the platform body 262. It is contemplated that one or more items 272 are attached to the cage 266 without directly contacting the platform body 262.

While any portion of the cage 266 can be affixed in place relative to the platform body 262, various embodiments configure portions of the cage 256 to move relative to the platform body 262. As illustrated in FIG. 8, the cage 266 can be split in half and connected to the platform body 262 via one or more movement mechanisms that allow portions of the cage 266 to have manual or automated movement relative to the platform body 262. For instance, a movement mechanism can consist of a track that allows contained movement of the cage 266 laterally. In other non-limiting movement mechanism configurations, actuators, gears, pistons, or pivots can be positioned on the platform body 262 to allow portions of the cage 266 to change position while the platform body 262 remains stationary.

In some embodiments, portions of the cage 266 are moved automatically as part of a leveling strategy to control and maintain a center of gravity that promotes a stable, level platform body 262 position over time. For example, as items 272 are removed, added, or moved atop the platform body 262, a leveling module can articulate, or prompt a user to manually move, one or more portions of the cage 266 to alter the center of gravity for the platform body 262 without having to alter the position of one or more articulating legs, which can save power and preserve the leg's footing with respect to the underlying ground surface. The automated control of the cage 266 may further allow a leveling module to articulate portions of the cage 266 in response to external triggers, such as to allow access to the space 268, to restrict access to the space 268, to protect the space 268 from weather, or to prevent an item 272 from leaving the space 268.

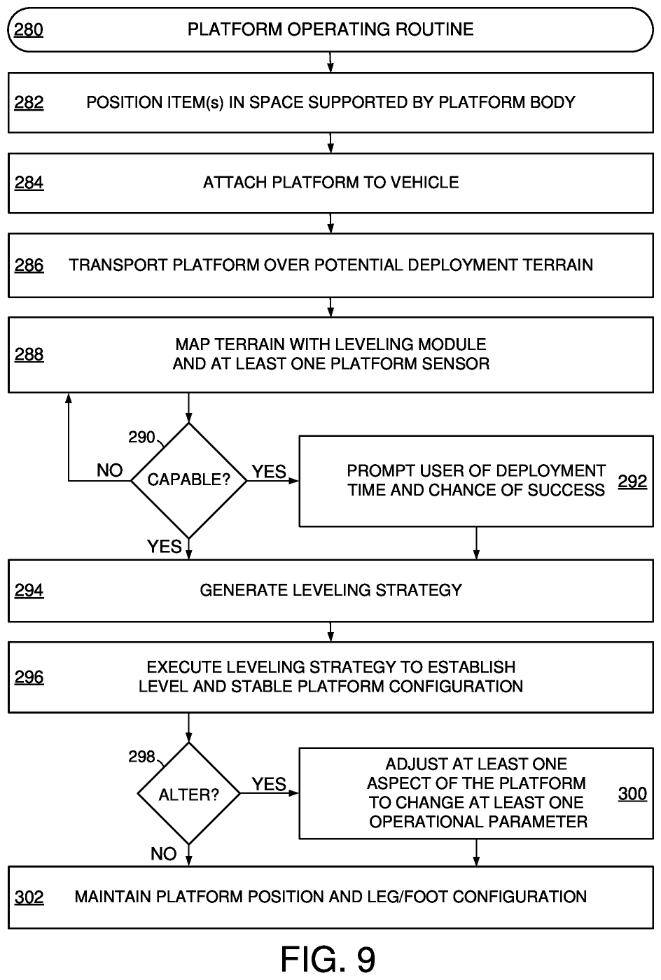

Through the intelligent deployment and maintenance of a platform, a stable, rigid, and level platform body 262 is established and aspect of the platform can be adapted over time in response to changing environmental and/or operational conditions. FIG. 9 conveys an example platform operating routine 280 that begins with one or more items being positioned atop a platform body in step 282. The items may be loose or secured and may be partially, or completely, contained within an enclosure that surrounds portions of the platform body.

With the platform ready to be moved to a different location, step 284 attaches the platform body to a transport vehicle, such as a truck or helicopter. The attachment of the platform to the vehicle in step 284 may involve articulating a tow mechanism or a hoist mechanism to allow physical connection of the platform to allow safe and efficient application of force to the platform without endangering the items supported by the platform. Next, the platform is transported over one or more potential deployment locations in step 286 where the terrain of the potential locations is mapped in step 288, as directed by a leveling module of the platform through the operation of at least one sensor of the platform, such as an acoustic, optic, or mechanical sensors.

The mapping of the terrain in step 288 allows the leveling module to determine if the platform can be deployed to provide a level and stable platform position in decision 290. That is, decision 290 evaluates if the current capabilities of the platform can establish and maintain a level platform configuration for a particular location. It is contemplated that decision 290 evaluates numerous different factors about the terrain to determine deployment capability, such as type of ground surface, presence of debris, moisture, slope, and undulations. The evaluation of decision 290 can produce a determination, by the leveling module, of how long deployment will take and the chance of a successful deployment that results in a stable and level platform configuration, which can be conveyed to a user in step 292.

After the leveling module alters the user of how long and the success chance of deployment in step 292, or in the event no user prompting is undertaken, step 294 proceeds to generate a leveling strategy with the leveling module. The leveling strategy prescribes actions based on the mapped terrain to move at least one leg and foot to engage the ground surface and establish the platform in a level orientation. Such actions are executed in step 296 as the platform's legs are articulated to physically contact a ground surface and position the platform body in a level orientation. Step 296 may further execute actions to manipulate the center of gravity of the platform body, supported items, or both, which can establish and maintain stability of the platform and the items resting thereon.

While the platform may remain in a level and stable configuration without any alterations to the operating parameters of the legs, feet, or cage, decision 298 evaluates if an alteration to an operating parameter can increase the stability of the platform and/or maintain the level orientation of the platform. If so, perhaps in reaction to changing weather conditions or movement of an item supported by the platform, step 300 adjusts at least one aspect of the platform, such as leg force, foot orientation, or cage position, to change at least one operational parameter of the platform, such as the center of gravity of the platform body. The alteration of an operating parameter in step 300, or in the event no alteration is executed, step 302 maintains the platform in a level and stable position until being moved to a different location.

What is claimed is:

1. A method comprising:
detecting a non-level terrain with at least one sensor connected to a control module;
generating a leveling strategy with the control module in response to the detected terrain;
positioning a unitary platform proximal to the non-level terrain; and
executing the leveling strategy with the leveling module to activate at least one articulating leg attached to the unitary platform to establish a level and horizontal orientation relative to the underlying non-level terrain.

2. The method of claim 1, wherein the non-level terrain is detected prior to physically contacting the non-level terrain.

3. The method of claim 1, wherein the control module is separated from the unitary platform and connected to the at least one sensor and at least one articulating leg via a wireless signal pathway.

4. The method of claim 1, wherein the leveling strategy prescribes different lengths for different articulating legs to establish a center of gravity of the unitary platform in a predetermined position relative to a body of the unitary platform.

5. The method of claim 1, wherein the leveling strategy prescribes articulation of at least one foot attached to the at least one articulating leg.

6. The method of claim 1, wherein the unitary platform is positioned proximal to the non-level terrain by an aircraft.

7. The method of claim 6, wherein the aircraft is connected to the unitary platform by a pair of arms each extending from a periphery of a body of the unitary platform.

8. The method of claim 7, wherein each of the arms of the pair of arms rotate relative to the body to physically contact the non-level terrain and support the unitary platform.

9. The method of claim 1, wherein the unitary platform is positioned proximal the non-level terrain by a vehicle.

10. The method of claim 9, wherein the vehicle is connected to unitary platform by a towing assembly.

11. The method of claim 1, wherein the control module detects a real-time center of gravity of the unitary platform with at least one sensor.

12. The method of claim 11, wherein the control module alters the at least one articulating leg, in accordance with the predetermined leveling strategy, in response to a change in the unitary platform center of gravity to maintain a body of the unitary platform in the level and horizontal orientation.

13. The method of claim 1, wherein the leveling strategy prescribes a number of different actions to maintain a body of the unitary platform in the level and horizontal orientation in response to predicted changes to a center of gravity of the unitary platform.

14. An apparatus comprising a unitary platform positioned between articulating legs, each articulating leg connected to a control module configured to execute a leveling strategy in response to a detected terrain to extend at least one articulating leg to establish the unitary platform in a level and horizontal orientation relative to an underlying, non-level terrain.

15. The apparatus of claim 14, wherein the unitary platform is uniformly rigid concrete with at least a 25,000 psi rating.

16. The apparatus of claim 14, wherein the at least one articulating leg is hydraulically operated with a hydraulic assembly.

17. A method comprising:
detecting a non-level terrain with at least one sensor connected to a control module;
generating a leveling strategy with the control module in response to the detected terrain;
mapping a first region of a non-level terrain with the control module;
determining, with the control module, a level and uniformly horizontal orientation of a unitary platform cannot be supported on the first region of the non-level terrain in response to the mapping;
positioning a unitary platform proximal to a second region of the non-level terrain; and
executing the leveling strategy with the leveling module to activate at least one articulating leg attached to the unitary platform to establish a level and horizontal orientation relative to the underlying second region of the non-level terrain in response to determining the second region can support the level and horizontal orientation.

18. The apparatus of claim 17, wherein the leveling strategy is altered by the control module in response to the mapping of the second region of the non-level terrain.

19. The apparatus of claim 17, wherein the leveling strategy is executed to alter the at least one articulating leg in response to movement of a cage attached to a base of the unitary platform to maintain the level and horizontal orientation of the unitary platform as well as maintain a position of a center of gravity for the unitary platform.

20. The apparatus of claim 14, wherein the at least one articulating leg is hydraulically operated with a hydraulic assembly.
